(19) United States
(12) Patent Application Publication
(10) Pub. No.: US 2009/0135001 A1
(43) Pub. Date: May 28, 2009

(54) Pressure sensing system

(76) Inventor: Lo Tong Yuk, Hong Kong (HK)

Correspondence Address: Theresa O'Rourke Nugent, Esq.;Law Office of Sergel Orel, LLC, 660 Anderson Ave, Cliffside Park, NJ, 07010, US

(21) Appl. No.: 12/290,251

(22) Filed: Oct. 28, 2008

Related U.S. Application Data
(60) Provisional application No. 61/001,565, filed on Nov. 2, 2007.

(51) Int. Cl. G08B 1/08; G08B 23/00; G08B 21/00

(52) U.S. Cl. 340/539.11; 340/573.1; 340/665

(57) ABSTRACT

A system includes a pressure sensor communicating directly, or indirectly, via a data processor, with a feedback device. The pressure sensor is located in an athletic surface, such as in footwear, sports boards, decks, or the like, to measure the pressure and/or force transmitted to a user's leg, ankle, knee, and so forth. The feedback device produces a signal, optionally an audible, visible, and/or tactile signal, to alert the user that the pressure or force has exceeded a pressure threshold.

### RELATED APPLICATIONS

This application is a continuation of provisional application 61/001,565 filed Nov. 2, 2007 entitled “Pressure Sensing System” the contents of which are incorporated by reference herein.

### FIELD OF THE INVENTION

The present invention relates to pressure sensing systems. More specifically, the present invention is a pressure sensor mountable in an athletic surface, such as footwear, sports board, deck, or the like, that communicates to at least one feedback device to inform the user of the pressure readings from the pressure sensor.

### BACKGROUND OF THE INVENTION

Many activities are considered “high impact” activities because of the force transmitted to the participant's body. Such “high impact” activities, such as running, basketball, tennis, or the like, can cause wear on the participant's joints over time. Additionally, participants in such “high impact” activities are prone to traumatic injury. Despite the high risk of injury, these activities are highly popular.

Improvements to playing surfaces tend to reduce the impact on the participants. For example, many running surfaces are rubberized or otherwise cushioned, so that the pressure imparted on the participant and transmitted to the participant's body are somewhat reduced. However, these cushioned surfaces cannot alert the participant when a particular move has potentially generated a dangerously high force or pressure on the participant.

Similarly, shoes have been improved to reduce the impact on the participants. Shoes have been engineered to provide more support and more cushioning to the wearer's feet to thereby reduce the pressure and force transmitted to the wearer's legs and body. Examples of such improvements include soles that incorporate air or other gases, gels, or the like to distribute and diffuse high impacts. However, like the cushioned surfaces, these cushioned shoes do not alert the user when a particular move generates a dangerous level of pressure and force on the participant. U.S. Pat. No. 5,678,448 to Fullen et al. (hereinafter “Fullen”) is an example of conventional footwear with a pressure sensor installed therein. The Fullen patent describes the prior art foot pressure sensor that covers the entirety of the bottom of the user's foot when the footwear is worn. It has an annunciator attached to the footwear that audibly alerts the user when a predetermined pressure level has been exceeded. However, the Fullen pressure sensor relates only an average impact pressure of the entire foot. The reference is unable to distinguish a high heel pressure from a pressure under the ball of the user's foot. In sporting events, the vast majority of foot and leg fractures are caused by stress to the user's heel. Excessive pressure or repeated high pressures to the user's heel can cause stress fractures. The Fullen patent is unable to accurately read high pressures to the heel and warn of excessive heel impact pressure because it averages out the impact pressure on the entire foot.

### SUMMARY OF THE INVENTION

The present invention includes a pressure sensor. The pressure sensor is mounted in an athletic surface. The athletic surface may be any surface contacted by a user's foot, such as footwear, a sports board, a deck, or the like.

In one optional embodiment, the pressure sensor is mounted in footwear. In an optional embodiment, the pressure sensor is integrated into the footwear. In another optional embodiment, the pressure sensor may be retrofitted into the footwear by placing the pressure sensor on, in, or under an insole in the footwear.

In another optional embodiment, the pressure sensor is mounted in or to a sports board, such as a skateboard, snow board, ski, or the like. In one optional embodiment, the pressure sensor may be on a surface of the sports board. In another optional embodiment, the pressure sensor may be embedded into the sports board.

In yet another optional embodiment, the pressure sensor is mounted in or to a deck, such as a treadmill, exercise machine, track surface, or the like. Optionally, the pressure sensor may be on the surface of a deck, or embedded into a deck.

The pressure sensor communicates with at least one feedback device. In an optional embodiment, the pressure sensor may communicate with multiple feedback devices. The feedback device may include a device using tactile feedback, visible feedback, and/or audible feedback to alert the wearer of the pressure readings from the pressure sensor.

In a further optional embodiment, the pressure sensor and feedback device include a data processor. In one such optional embodiment, the data processor receives pressure readings from the pressure sensor and converts the pressure readings to feedback to the wearer or user. For example, in one such optional embodiment, the data processor may generate feedback to the wearer indicating that the pressure readings are potentially damaging to the wearer.

In operation, the pressure sensor measures pressures between the user's foot and the athletic surface. In an optional embodiment in which a data processor is included, the pressure readings are converted into feedback to the user through one or more feedback devices. In an alternate optional embodiment, pressure readings are directly communicated to the feedback device(s).

### BRIEF DESCRIPTION OF THE DRAWINGS

FIG. 1 is a cutaway side assembly view of a shoe and pressure sensor according to an embodiment of the present invention;

FIG. 2 is a side view of a wearer wearing a shoe and feedback device according to an embodiment of the present invention;

FIG. 3 is a block diagram of a system according to an embodiment of the present invention;

FIG. 4 is a block diagram of a system according to an embodiment of the present invention;

FIG. 5 is a block diagram of a system according to an embodiment of the present invention;

FIG. 6 is a block diagram of a system according to an embodiment of the present invention;

FIG. 7 is a block diagram of a system according to an embodiment of the present invention;

FIG. 8 is a block diagram of a system according to an embodiment of the present invention;

FIG. 9 is a side view of a sports board and pressure sensor according to an embodiment of the present invention;

FIG. 10 is a side view of a sports board and pressure sensor according to an embodiment of the present invention;

FIG. 11 is a side view of a deck and pressure sensor according to an embodiment of the present invention.

### DETAILED DESCRIPTION

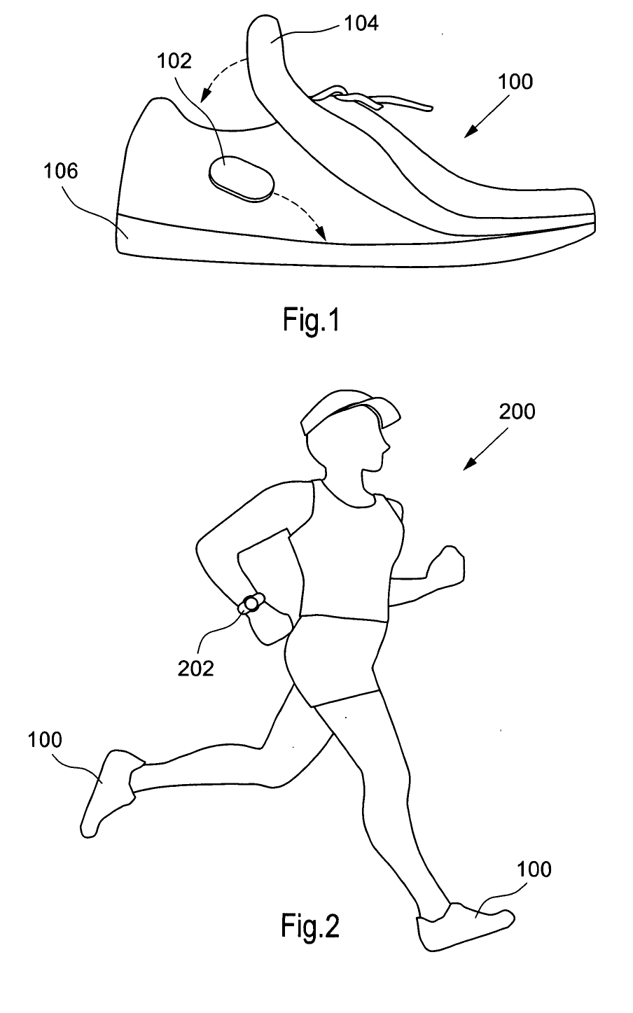

Reference is now made to the figures wherein like parts are referred to by like numerals throughout. Referring generally to FIGS. 1-8, a system and method according to an embodiment of the present invention is directed for use in combination with an athletic surface contacted by a user's foot. The athletic surface may take any configuration. For example, the athletic surface may be in the form of footwear, a sports board, a deck, or any other form.

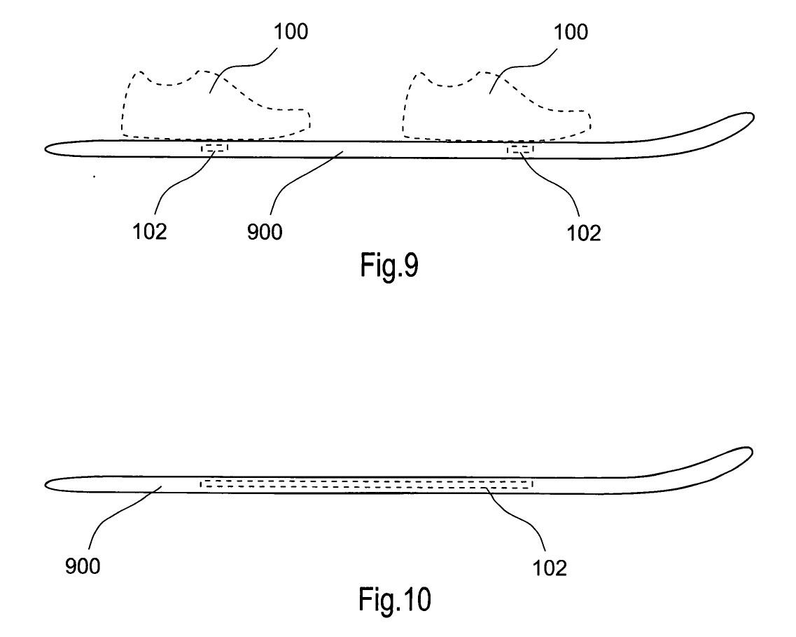

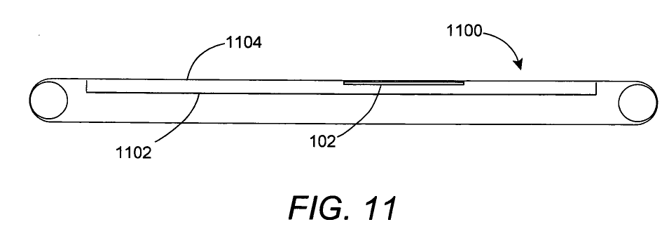

For example, in the optional embodiment illustrated in FIGS. 1 and 2, a pressure sensor 102 may be mounted in footwear 100. Preferably, the pressure sensor 102 may be installed directly below the user's heel. The pressure sensor 102 may be any of the type known to those skilled in the art. For example, experimental data was obtained using a circular sensor of the type made by Interlink Electronics (Force Sensing Resistor Model 402). The type of footwear 100 is not limited to those shown in the FIGS. 1 and 2. It is noted that the footwear 100 may have any configuration, including shoes, ice or roller skates, roller blades, boots, ski or snow board boots, or any other footwear 100. In the optional embodiment illustrated in FIGS. 9 and 10, a pressure sensor 102 may be mounted to, or in, a sports board 900. The sports board 900 is not limited to those shown in FIGS. 9-10. Again, it is contemplated that the sports board 900 may take any form, including a snow or water ski, snow board, skate board, surf board, or the like. In the optional embodiment illustrated in FIG. 11, a pressure sensor 102 may be mounted to, or in, a deck 1102. In the example illustrated in FIG. 11, the deck 1102 is part of a treadmill 1100. However, it is contemplated that the deck could take any form, including the deck of an exercise machine (such as a stair machine, elliptical trainer, weight lifting machine, or the like), a court or track surface, or the like.

Referring generally to FIGS. 1 and 9-11, a pressure sensor 102 is provided. The pressure sensor 102 may take any form. For example, in an optional embodiment, the pressure sensor 102 is a gauge that converts compression force over a defined area of the gauge into an electric signal. In one such optional embodiment, the electric signal varies with changes in the compression force. Since the area remains substantially constant, such a gauge produces an electrical signal that can be converted into a pressure reading.

With reference to FIGS. 1 and 2, the pressure sensor 102 may be mounted in footwear 100. In an optional embodiment, the pressure sensor 102 is positioned such that the pressure reading measured by the pressure sensor 102 is the pressure transferred to the foot, knee, and leg of the user 200. For example, in one optional embodiment, the pressure sensor 102 is positioned beneath the foot area within the footwear 100. In this regard, the pressure sensor 102 may be integrally formed with the insole 104 of the footwear 100; integrally formed with the sole 106 of the footwear 100; mounted on, in, or beneath, the insole 104 of the footwear 100, such as in a receptacle or pocket formed in the insole 104 or the sole 106; or otherwise received into, or onto the footwear 100 at a position where it can measure the pressure transmitted to the user 200. As may be appreciated, multiple pressure sensors 102 may be used in an optional embodiment.

Turning to FIGS. 9 and 10, the pressure sensor 102 may be in or on a sports board 900. More specifically, the pressure sensor 102 may be integrally formed with, or embedded into, the sports board 900 or mounted to the surface of the sports board 900. In an optional embodiment, the pressure sensor 102 is positioned in or on the sports board 900 so that the pressure measured by the pressure sensor 102 is the pressure transferred to the foot, knee, and leg of the user 200. For example, in one optional embodiment, the pressure sensor 102 is positioned beneath the foot area on which the user would stand when using the sports board 900. Optionally, multiple pressure sensors 102 may be included so that pressure measurements could be taken for each of the user's feet (as shown in FIG. 9) or in the case where the user may place his feet at many different locations along the sports board 900. In another optional embodiment (shown in FIG. 10), the pressure sensor 102 may be sized to cover a broad area where the user may stand on the sports board 900.

In yet another optional embodiment, the pressure sensor 102 may be in or on a deck. More specifically, the pressure sensor 102 may be mounted on the surface of, integrally formed with, or embedded into, a deck. The deck could take many different forms including the surface of an indoor or outdoor track, a court surface (such as a tennis court, basketball court, or the like), the deck of an exercise machine, or the like. In the example of FIG. 11, the pressure sensor 102 is mounted on, or integrated in, the deck 1102 of a treadmill 1100. It is noted that this same configuration could be applied to the other examples of decks given above. In the optional embodiment of FIG. 11, the pressure sensor 102 is mounted beneath a moving belt 1104 on which a user walks or runs. In this manner, the pressure sensor 102 is positioned so that the pressure measured by the pressure sensor 102 is the pressure transferred to the foot, knee, and leg of the user 200. In the optional embodiment of FIG. 11, a pressure sensor 102 spans an area of the deck 1102. However, it is contemplated that in alternate optional embodiments, different configurations of single or multiple pressure sensors could be used.

Referring to FIGS. 2-8, the pressure sensor 102 communicates with a feedback device 202. The feedback device 202 may take any form. Optionally, the feedback device 202 is associated with the user 200 of the footwear 100 so that the feedback signal generated by the feedback device 202 is available to the user 200. For example, the feedback device 202 may secure to the user 200 or to the user's 200 clothing. In FIG. 2, the feedback device 202 is a mounted to the user's 200 wrist. In alternate optional embodiments, the feedback device 202 may be secured to other portions of the user's 200 body or to the user's 200 clothing. Optionally, the type of feedback generated may influence where the feedback device 202 is located. For example, if the feedback device 202 generates an audible signal, the feedback device 202 may optionally be located where the user 200 will hear the audible signal. Similarly, if the feedback device 202 generates a visible signal or a tactile signal, the feedback device 202 may optionally be located where the user 200 will see or feel the visible or tactile signal, respectively.

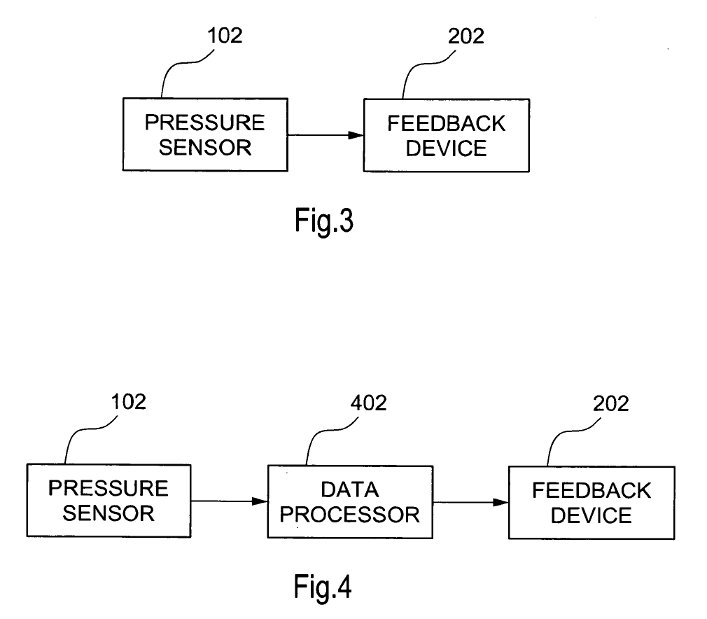

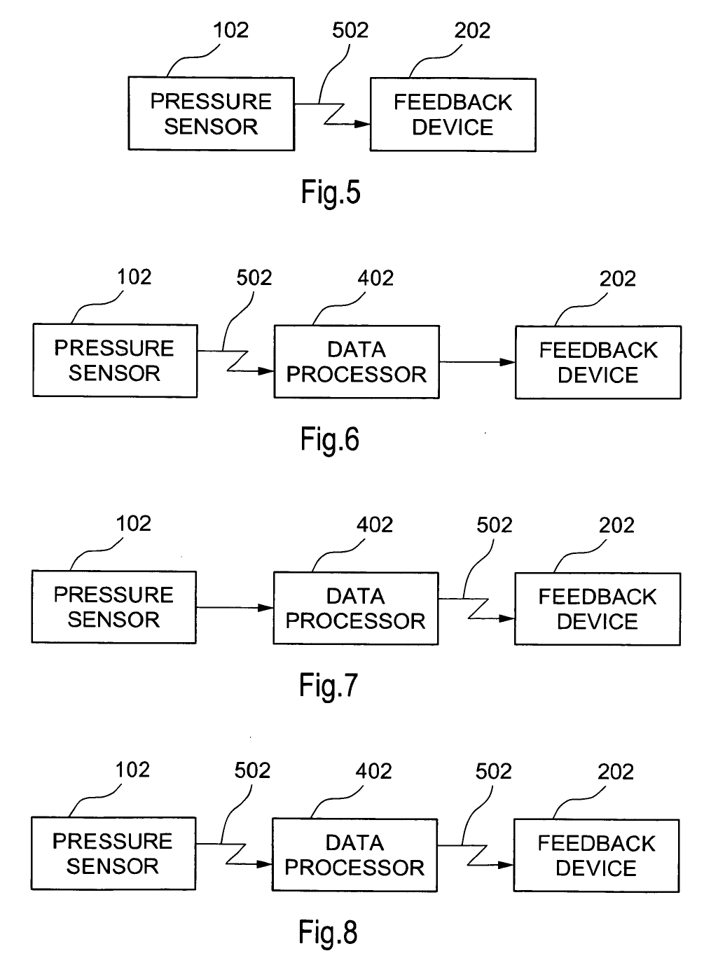

In an optional embodiment, shown in FIGS. 3 and 5, the pressure sensor 102 may communicate directly with the feedback device 202. In one such optional embodiment in which the pressure sensor 102s communicate directly with the feedback device 202, the feedback device 202 may optionally include a switch, comparator, or other controller or processor to determine if the signal from the feedback device 202 exceeds a predetermined level, thereby indicating that the pressure has exceeded the pressure threshold level.

In another optional embodiment, shown in FIGS. 4 and 6-8, the feedback device 202 and sensor may communicate with a data processor 402. In one such optional embodiment, a data processor 402 may be included to digitally compare the pressures sensed by the pressure sensor 102 with the pressure threshold. In an optional embodiment, the data processor 402 may also be programmed (through software, firmware, or the like) to perform additional tasks as well, such as generate displays or audible signals for output at the feedback device 202.

Referring generally to FIGS. 3-8, the pressure sensor 102 may communicate with the output device (directly or indirectly through the data processor 402) through a wire connection or wirelessly. In an optional embodiment in which the communication is wireless, the carrier may take any form of electromagnetic wave, including radio waves, microwaves, or the like. Similarly, the communication protocol may take any form, including any of the computer networking protocols, Bluetooth™, or any other established or newly-created protocol. In such an optional embodiment, the pressure sensor 102 may incorporate or communicate with a wireless transmitter and/or wireless receiver. Similarly, the feedback device 202 may incorporate or communicate with a wireless receiver and/or wireless transmitter. In an optional embodiment including a data processor 402, the wireless receiver and/or wireless transmitter may communicate with the data processor 402 which, in turn, communicates with the feedback device 202.

For example, as shown in FIG. 5, a wireless signal 502 may be communicated from the pressure sensor 102 to the feedback device 202. While this signal is shown as unidirectional, it is noted that the pressure sensor 102 may be adapted to receive, as well as send, wireless signals. Similarly, as shown in FIGS. 6-8, a wireless signal 502 may occur between a pressure sensor 102 and a data processor 402 as shown in FIG. 6, between a data processor 402 and a feedback device 202 as shown in FIG. 7, or both as shown in FIG. 8.

In an optional embodiment, the pressure sensor 102 may communicate with multiple feedback devices 202. The feedback devices 202 may take many different forms. For example, the feedback device 202 may employ audio, video, and/or tactile alerts to inform the user 200 of the pressures sensed by the pressure sensor 102. Thus, the feedback device 202 could, in various optional embodiments, generate an audible sound, visible signal (such as a display, light, dial, or the like), or tactile signal (such as a vibration, buzz, or the like) that will alert the user 200 of the pressure sensed or, in an optional embodiment, when the pressure sensed has exceeded a predetermined pressure threshold. In an optional version of the latter embodiment, the predetermined pressure threshold may be fixed or may be selectable by the user 200. It is also contemplated that, in an optional embodiment, a combination of fixed and selectable pressure thresholds may be used.

It is noted that in any of these embodiments, the feedback device 202 may be limited to alerting the user 200 when the pressures exceed a predetermined pressure threshold level (or multiple predetermined pressure threshold levels). For example, in one such optional embodiment, the feedback device 202 may be in a “safe” mode until the pressure sensed at the pressure sensor 102 exceeds a pressure threshold level. When the pressures exceed the pressure threshold level, the feedback device 202 may shift to a “warning” mode in which the user 200 is alerted that the pressure threshold has been exceeded. As discussed above, this could include a visible signal, an audible signal, and/or a tactile signal. In an optional embodiment, the “warning” mode may be cancelled when the pressure is reduced below the pressure threshold. Additionally or alternatively, the user 200 may be required to reset the feedback device 202 to cancel the “warning” mode and revert to the “safe” mode.

In a further optional embodiment, the feedback device 202 may additionally inform the user 200 of the specific pressure sensed. In one such optional embodiment, a display, dial, audible speaker, or the like may provide a specific reading of the pressure sensed at the pressure sensor 102. The feedback device 202 of such an optional embodiment could be actuated in many different ways. For example, in various optional embodiments, the pressure reading may be provided at regular intervals, upon reaching a predetermined pressure threshold, on demand, or in any other fashion.

In use, a user 200 of the feedback device 202 performs his or her activities on an athletic surface, e.g. in footwear, on a sports board, on a deck, or the like, that incorporates the pressure sensor 102. As discussed, in an optional embodiment, the user 200 may be able to use the feedback device 202 to determine the pressures sensed when they are not above the threshold level. When the pressures sensed by the pressure sensor 102 exceed the threshold level, such as during athletic activities like running, jumping, or the like, the feedback device 202 provides a signal to the user 200. As noted above, this could include a shift to a “warning” mode in which the feedback device 202 generates an audible, visible, or tactile signal. In various optional embodiments, the signal may be ceased after a predefined period of time, after the pressures sensed fall below the pressure threshold level, after the user 200 resets the feedback device 202, or the like.

While certain embodiments of the present invention have been shown and described, it is to be understood that the present invention is subject to many modifications and changes by those skilled in the art without departing from the spirit and scope of the invention presented herein.

What we claim is:

1. A method of alerting a user to a condition comprising:
providing a sensor between the user's foot and a surface;
using the sensor to monitor the condition;
providing a feedback module worn above the user's waist;
providing a communication link between the sensor and the feedback module;
using the sensor to determine a state of the condition;
using the feedback module to alert the user when the condition exceeds a predetermined level.

2. The method of claim 1, further comprising:
providing the communication link as a wireless communication link.

3. The method of claim 1, further comprising:
providing the surface as at least one selected from the group consisting of footwear, an athletic surface, a sports board, a sports deck and a deck of an exercise machine.

4. The method of claim 1, further comprising:
providing the feedback module as an electronic device;
using the sensor as a pressure sensor;
obtaining the state of the condition as an impact force condition.

5. The method of claim 4, further comprising:
providing the electronic device as a wrist watch;
providing the alert as at least one selected from the group consisting of audible, visual and tactile.

6. A method of alerting a user to a pressure condition comprising:
providing a pressure sensor between a user's foot and a surface;
providing a feedback module separate from a user's footwear;
establishing a communication link between the pressure sensor and the feedback module;
using the pressure sensor to determine a state of pressure;
using the communication link to transmit the state of pressure to the feedback module;
using the feedback module to alert the user when the pressure condition exceeds a predetermined pressure threshold.

7. The method of claim 6, further comprising:
providing the communication link as a wireless communication link.

8. The method of claim 6, further comprising:
providing the surface as at least one selected from the group consisting of an athletic surface, a sports board, a sports deck and a deck of an exercise machine.

9. The method of claim 7, further comprising:
providing the wireless communication link as a Bluetooth™ communication link.

10. The method of claim 9, further comprising:
installing the pressure sensor directly below a user's heel in the footwear;
determining the state of pressure using the pressure sensor installed directly below the user's heel;
determining the state of pressure during a sporting activity;
setting the predetermined pressure threshold based on the sporting activity;
alerting the user to an unsafe condition based on the sporting activity and the predetermined pressure threshold.

11. A device for alerting a user to a condition comprising:
a sensor to monitor the condition between the user's foot and a surface;
a feedback module worn above the waist by the user;
a communication link between the sensor and the feedback module;
wherein the feedback module alerts the user when the condition exceeds a predetermined level.

12. The device of claim 11, further comprising:
the communication link is a wireless communication link.

13. The device of claim 11, further comprising:
the surface is at least one selected from the group consisting of footwear, an athletic surface, a sports board, a sports deck and a deck of an exercise machine.

14. The device of claim 11, further comprising:
the feedback module is an electronic device;
the sensor is a pressure sensor;
wherein the condition is an impact force condition.

15. The device of claim 14, further comprising:
the electronic device is a wrist watch;
wherein the alert is at least one selected from the group consisting of audible, visual and tactile.

16. A device for alerting a user to a pressure condition comprising:
a pressure sensor to measure a pressure between a user's foot and a surface;
a feedback module separate from a user's footwear;
a communication link between the pressure sensor and the feedback module;
wherein the communication link transmits a state of pressure to the feedback module and;
wherein the feedback module alerts the user when the pressure exceeds a predetermined pressure threshold.

17. The device of claim 16, further comprising:
the communication link is a wireless communication link.

18. The device of claim 16, further comprising:
the surface is at least one selected from the group consisting of an athletic surface, a sports board, a sports deck and a deck of an exercise machine.

19. The device of claim 17, further comprising:
the wireless communication link is a Bluetooth™ communication link.

20. The device of claim 19, further comprising:
the pressure sensor is installed only directly below a user's heel in the footwear;
wherein the state of pressure is determined during a sporting activity;
wherein the predetermined pressure threshold is set based on the sporting activity and;
wherein the user is alerted to an unsafe condition based on the sporting activity and the predetermined pressure threshold.

21. An apparatus for alerting a user to a condition comprising:
a sensor to monitor the condition between the user's foot and a surface;
a feedback module worn above the waist by the user;
a communication link between the sensor and the feedback module;
wherein the feedback module alerts the user when the condition exceeds a predetermined level.

22. The apparatus of claim 21, further comprising:
the communication link is a wireless communication link.

23. The apparatus of claim 21, further comprising:
the surface is at least one selected from the group consisting of footwear, an athletic surface, a sports board, a sports deck and a deck of an exercise machine.

24. The apparatus of claim 21, further comprising:
the feedback module is an electronic device;
the sensor is a pressure sensor;
wherein the condition is an impact force condition.

25. The apparatus of claim 24, further comprising:
the electronic device is a wrist watch;
wherein the alert is at least one selected from the group consisting of audible, visual and tactile.
